(19) United States
(12) Patent Application Publication
(10) Pub. No.: US 2025/0370488 A1
(43) Pub. Date: Dec. 4, 2025

(54) ENERGY OPTIMIZATION OF A HEAT TRANSPORT SYSTEM

(71) Applicant: Grundfos Holding A/S, Bjerringbro (DK)

(72) Inventors: Jan Caroe AARESTRUP, Bjerringbro (DK); Mogens Groth NICOLAISEN

(21) Appl. No.: 18/869,792

(22) PCT Filed: Jun. 8, 2023
(86) PCT No.: PCT/EP2023/065380

§ 371 Date: Nov. 26, 2024

(30) Foreign Application Priority Data
Jun. 10, 2022 (DK) PA202270314
Jun. 16, 2022 (DK) PA202270323

(51) Int. Cl. G05D 23/19

(52) U.S. Cl. CPC G05D 23/1917

(57) ABSTRACT

A method for optimizing the energy consumption of a heat transport system is provided. Preferred embodiments of the method comprise recurrent steps of recording a power change in a summed power consumption resulting from a change in an optimization parameter introduced into the heat transport system, determining a new to be introduced change to the optimization parameter and introducing the new to be introduced change into the heat transport system.

### FIELD OF THE INVENTION

The present invention relates to a method for optimizing the energy consumption of a heat transport system. Preferred embodiments of the method comprising the recurrent steps of recording a power change in a summed power consumption resulting from said change in an optimization parameter introduced into the heat transport system; determining a new to be introduced change to the optimization parameter and introducing the new to be introduced change into the heat transport system.

### BACKGROUND OF THE INVENTION

A heat transport system often involves a heat transport device transporting heat from one reservoir to another. In such systems, the exchange of heat in the reservoirs as well as the heat transport device involves an electrical power consumption.

Heat transport systems typically comprises a number of units such as a cooling tower, a heat pump unit and a thermal load. These units are connected to form the heat transport device and each of such units are typically controlled by a control function specifically designed to provide a predefined temperature set-point for the units.

Optimization of the power consumption of a heat transport device, which is reducing the amount of power consumed to achieve a certain goal for cooling or heating is often of paramount interest for an operator and/or owner of the heat transport system.

A common approach in optimization of heat transport systems is to build a mathematical model of the system and use this model to seek a state of minimal power consumption. One such example is provided by EP3194865B1.

Although such model based approaches are workable solutions towards optimization of power consumption, they are bound by the fact that the various components of the heat transport system must be well disclosed and understood as well as requiring access to a plurality of variables for the system.

Hence, an improved optimization would be advantageous, and in particular a more efficient and/or reliable optimization would be advantageous.

OBJECT OF THE INVENTION

It is a further object of the present invention to provide an alternative to the prior art.

In particular, it may be seen as an object of the present invention to provide an optimization that solves the above mentioned problems of the prior art.

### SUMMARY OF THE INVENTION

Thus, the above described object and several other objects are intended to be obtained in a first aspect of the invention by providing a method for optimizing the energy consumption of a heat transport system, said heat transport system preferably comprising:
a first thermal load, a heat transport device and a second thermal load, said heat transport device being configured to
   a) extract heat from a first fluid circulating by use of a first pump between a heat absorption side of said heat transport device and said second thermal load and supply at least a fraction of said heat to a second fluid circulating by use of a second pump between said first thermal load and a heat rejection side of said heat transport device;
      wherein.
operation of said first thermal load and said second pump, said heat transport device and said second thermal load and said first pump each requires a power consumption;
the method is based on an optimization parameter indicative of or representing a summed power consumption for two or more components of the heat transport system, wherein said summed power consumption being a sum of at least two of said power consumptions which when summarized has a convex power consumption characteristic as a function of the optimization parameter and wherein said summed power consumption is changeable by introducing a change to the optimization parameter into the heat transport system, the method preferably comprising, the steps of:
   a) determining when the heat transport system is in steady state a first to be introduced change in the optimization parameter and introducing said first to be introduced change into the heat transport system;
   b) recording when the heat transport system is in steady state, a power consumption change in said summed power consumption resulting from said change in said optimization parameter introduced into said heat transport system;
   c) determining a new to be introduced change to the optimization parameter, wherein said new to be introduced change results in:
      an increase in said optimization parameter, if a rate of change in summed power consumption with respect to said optimization parameter is smaller than zero, and
      a decrease in said optimization parameter, if said rate of change in summed power consumption with respect to said optimization parameter is larger than zero,
   d) introducing when the heat transport system is in steady state said new to be introduced change into the heat transport system and repeating steps b) to d).

Preferably, the rate of change in summed power consumption with respect to said optimization parameter is determined by evaluating

$$\frac{{dP}_{sum}}{{dV}_{opti}} or \frac{Δ {P}_{sum}}{Δ {V}_{opti}} .$$

For the discrete formulation

$$\frac{Δ {P}_{sum}}{Δ {V}_{opti}}$$

in step c), this may symbolically be written as

$$\frac{Δ {P}_{sum}}{Δ {V}_{opti}} = \frac{{P}_{sum , t} - {P}_{sum , t - 1}}{{V}_{opti , t} - {V}_{opti , t - 1}}$$

where t refers to the time where step c) is carried out, and t−1 refers to a time where previous step c) and a subsequently step b) have been carried out. Accordingly, step c) preferably involves a determination of rate of change in summed power consumption with respect to said optimization parameter, where the determination is carried out based on two consecutive occurring steady states.

As detailed herein, introducing a change in the optimization parameter into the heat transport system may in many instances result in that the heat transport system changes state before entering into steady state again. Accordingly, the steady state referred to in step b) above, may be referred to “a new steady state” in the sense that the system has regained steady state after the introduced change in optimization parameter.

By such a method, the feed-back received from the heat transport system upon introducing a change is a feed-back determined by the system itself and not by a mathematical model, e.g., a mathematical model based on physic, an artificial intelligence based model or machine learning models, of the system, whereby any uncertainty as to whether or not a correct representation by the model of the heat transport system is observed has at least been mitigated.

As preferred embodiments of the invention do not rely on a mathematical model but on a real feed-back from the system, wear and tear of the model parameters do not need modifications to reflect such and other changes to the system. This may preferably be summarized as the method being model-less or model independent.

Further, as the method may use parameter being indicative of a summed power consumption, the method may easily be implemented as there often is no need to equip the system with delicate and expensive sensors. Preferred embodiments of the invention also provide the possibility of using sensors, such as flow and/or temperature sensors already present in the heat transport system. However, in some embodiments, one or more power sensors may be fitted to the heat transport system to provide power consumption readings.

Terms used herein are used in a manner being ordinary to a skilled person. Some of the used terms are elucidated here below:

Rate of change of summed power consumption with respect to the optimization parameter, or in short form “rate of change” is used to reference

$$\frac{{dP}_{sum}}{{dV}_{opti}} or \frac{Δ {P}_{sum}}{Δ {V}_{opti}} .$$

Heat transport device is used to reference a device configured to transport heat from a first reservoir to a second reservoir having a higher temperature than the temperature of the first reservoir. In preferred embodiments, such a heat transport device may be a heat pump or a chiller although the invention is not limited to such heat pumps or chillers. It is noted that a heat pump and a chiller may or may not comprise similar major components such as a compressor, a condenser, an evaporator and throttling device, and that a heat pump typically refers to a need for generating heat whereas a chiller typically refers to a need for cooling.

Power consumption is used to reference either a total power consumption of a device or a partial power consumption for one or more specific components of the device. Non-limiting examples on such components are fan(s), pump(s), heat transport fan(s), cooling tower spray pump(s), condenser pump(s), evaporator primary pump(s), evaporator secondary pump(s), compressor of a heat transport device, and other components comprised in the heat transfer system having a controllable power consumption.

A Cooling tower as referred to herein may be a dry cooling tower including a heat exchanger or wet cooling tower including a heat exchanger where water is poured and/or sprayed onto the heat exchanger to further increase the release of heat from the fluid flowing in the heat exchanger.

Component is typically used to reference a power consuming device forming part of e.g. a heat load, a cooling load or a heat transport device, and/or e.g. a circulating pump, such as the first and second pump.

Steady state is preferably used to reference a state reached by the heat transport system after a settling time has elapsed and after a change in the optimization parameter has been imposed. The settling time is typically dependent on the heating system and is typically influenced by the size of the heat transport system. The settling time may be determined experimentally. In some embodiments, steady state refers to a state where the summed power consumption, Pₛᵤₘ, does not change more than 5% such as more than 2.5% evaluated over a time period of typically 5.0 minutes or more, preferably less than 15.0 minutes. Such a steady state may be referred to as a plateau as Pₛᵤₘ is constant over time. The length of the time period and the percentage of change may be changeable parameters, often depending on the dynamics of the heat transport system.

Preferred embodiments of the invention are preferably computer implemented in the sense that a computer is used to carry out various computational operations. Further, a heat transfer system according to preferred embodiments is typically equipped with one or more sensors configured to determine actual values of the power consumption or values from which the power consumption is derivable. Sensor(s) may be provided to determine actual values of optimization parameters. Typically, these sensors include but not limited to a temperature sensor, a pressure sensor, an electrical power consumption sensor, electrical current sensor, rotational speed sensor and the like. Output from such sensor(s) is typically input to the computer.

Further, the computer is typically adapted to introduce a change in the optimization parameter into the heat transfer system.

Thus, in a second aspect, the invention relates to a computer implemented method for optimizing the energy consumption of a heat transport system, said computer is configured to introduce a change said heat transport system comprising:
a first thermal load, a heat transport device and a second thermal load, said heat transport device being configured to
   a) extract heat from a first fluid circulating by use of a first pump between a heat absorption side of said heat transport device and said second thermal load and supply at least a fraction of said heat to a second fluid circulating by use of a second pump between said first thermal load and a heat rejection side of said heat transport device;
      wherein
operation of said first thermal load and said second pump, said heat transport device and said second thermal load and said first pump each requires a power consumption, and said heat transport system comprises one or more sensors adapted to provide a readout representing said power consumptions or a readout from which said power consumption may be derived;
the method is based on an optimization parameter indicative of or representing a summed power consumption for two or more components of the heat transport system, wherein said summed power consumption being a sum of at least two of said power consumptions which when summarized has a convex power consumption characteristic as a function of the optimization parameter and wherein said summed power is changeable by introducing a change to the optimization parameter into the heat transport system, the method comprising, the steps of:
   a) determining, by use of said computer receiving input from one or more of said sensors, when the heat transport system is in a steady state a first to be introduced change in the optimization parameter, said first to be introduced change into the heat transport system;
   b) recording, by use of said computer receiving input from one or more of said sensors, when the heat transport system is in a steady state, a power consumption change in said summed power resulting from said change in said optimization parameter introduced into said heat transport system;
   c) determining, by use of said computer, a new to be introduced change to the optimization parameter, wherein said new to be introduced change results in:
      an increase in said optimization parameter, if a rate of change in summed power consumption with respect to said optimization parameter is smaller than zero, and
      a decrease in said optimization parameter, if said rate of change in summed power consumption with respect to said optimization parameter is larger than zero,
   d) introducing, by use of said computer, when the heat transport system is in steady state said new to be introduced change into the heat transport system and repeating steps b) to d).

### BRIEF DESCRIPTION OF THE FIGURES

Preferred embodiments according to the invention will now be described in more details with regard to the accompanying figures. The figures show ways of implementing the present invention and are not to be construed as being limiting to other possible embodiments falling within the scope of the attached claim set.

FIG. 1 schematically illustrates a heat transport system according to a first embodiment of the invention;

FIG. 2 schematically illustrates a summed power consumption Pₛᵤₘ as function of optimization parameter;

FIG. 3 is a flow chart illustrating steps involved in a preferred embodiment;

FIG. 4 is a flow chart illustrating steps involved in a preferred embodiment;

FIG. 5 schematically illustrates a heat transport system according to a second embodiment of the invention in which the first thermal load comprising a cooling tower and the heat transport device comprising a heat pump;

FIG. 6 schematically illustrated a heat transport system according to a third embodiment of the invention in which the first thermal load comprising a dry cooler and the heat transport device comprising a heat pump;

FIG. 7 schematically illustrates a timewise evolution in Pₛᵤₘ as well as illustrating a plateau before and after introducing a change.

### DETAILED DESCRIPTION OF PREFERRED EMBODIMENTS

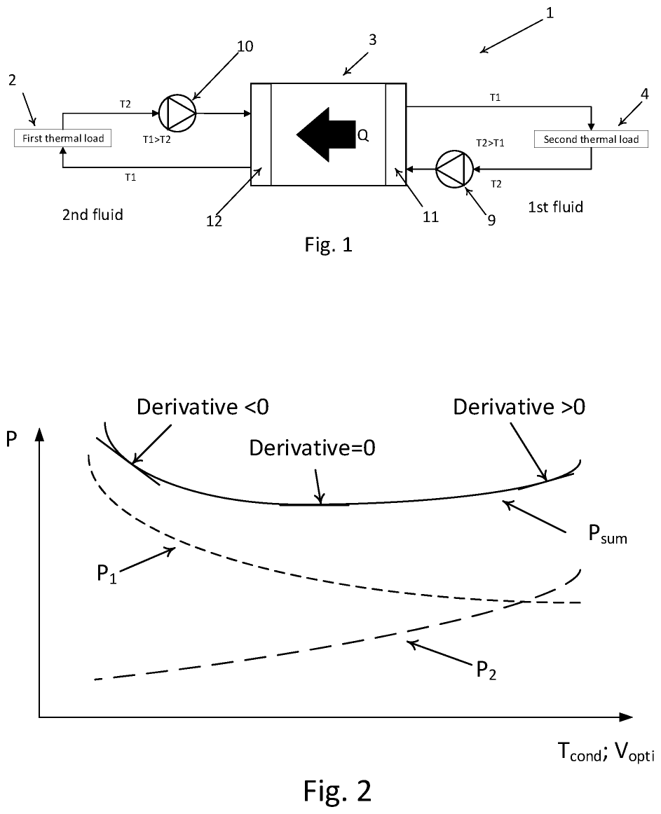

Reference is made to FIG. 1 schematically illustrating a heat transport system according to a preferred embodiment. The heat transport system comprises a first thermal load 2, a heat pump 3 and a second thermal load 4. The heat transport device being configured to extract heat from a first fluid circulating by use of a first pump 9 between a heat absorption side 11 of the heat transport device 3 and the second thermal load 4 and supply at least a fraction of said heat to a second fluid circulating by use of a second pump 10 between said first thermal load 2 and a heat transport side of 12 the heat transport device 3.

It is noted, that operation of the first thermal load 2 and second pump 9, the heat transport device 3 and the second thermal load 4 and first pump 10 each requires a power consumption, typically being electrical power.

To illustrate a preferred operation reference is made to FIG. 5 schematically illustrating an embodiment in which the first thermal load 2 comprises a cooling tower 7 and a second pump 10. The heat transport device 3 comprises a heat pump 13 including a condenser 5, an evaporator, a compressor and an expansion valve. The second thermal load 4 comprises a load to be cooled and an evaporator pump.

Reduction of energy in a system like the ones of FIG. 5 can be obtained by balancing cooling tower 7 effort, heat pump 13 and second thermal load 4 performance requirements. Within each of these three components, sub-optimization can lead to savings as e.g. cooling tower power consumption depends on both fan and spray pump duty. In the embodiment of FIG. 5, lowering condenser inlet temperature T_{2,cond} an increase in cooling tower power consumption P₁ is observed while heat pump 13 power consumption P₂ is reduced. Reducing requirements for the second thermal load 4 supply by increasing load side supply temperature T_{1,evap} reduces heat pump 13 power consumption as well. An example of this is schematically illustrated in FIG. 2. In FIG. 2, the cooling tower power consumption P₁ and the heat pump power consumption P₂ is plotted against the condenser difference between inlet and outlet condenser temperatures ΔT_{cond}=T_{2,cond}−T_{1,cond}. Such a difference is herein referred to as a controllable optimization variable Vₒₚₜᵢ. Also illustrated in FIG. 2 is the sum of the power consumption Pₛᵤₘ=P₁+P₂ plotted against Vₒₚₜᵢ.

In preferred embodiments, the first thermal load 2, the heat transport device 3 and the second thermal load 3 are each controlled by their own closed control loop, which operates independently of each other, so as to control each of the first thermal load 2, the heat transport device 3 and the second thermal load 4 to meet a given specific thermal reference often referred to as set-points.

Common for all or at least most of the close loop controllers of power consuming components, is that the close loop control tries to maintain a fixed set-point for a thermal condition of this component. The fixed set-point for these close loop controllers, is the same variable(s) as chosen for optimization parameter (Vₒₚₜᵢ), ex. For the cooling tower the close loop controller should maintain a set-point for the approach temperature. For the condenser pump flow controller, the close loop controller should maintain a set-point for the condenser differential temperature. While this is detailed with reference to specific embodiments, the concept is general and applicable to other embodiments as well.

By selecting a controllable optimization variable Vₒₚₜᵢ and observing power consumption of directly affected system components, a subset of the heat transport system 3 may be power consumption optimized. The components of heat transport system selected for observation are typically defined as having opposite slopes with respect to Vₒₚₜᵢ, meaning that the sum of power consumptions of the selected components must provide a convex curve with respect to Vₒₚₜᵢ as is seen on FIG. 2 where the sum of the power consumption Pₛᵤₘ has convex curve shape.

By having combined, e.g., summed power consumption as a convex function of Vₒₚₜᵢ renders it possible to perform an extremum seeking control to achieve power optimal control of the system. Essentially, any number of power contributions can be summed and used in preferred embodiments of the invention as long as the combined power provides a convex function with respect to the controllable optimization parameter Vₒₚₜᵢ. Table 1 here below lists some non-limiting examples on Vₒₚₜᵢ.

TABLE 1

| Vₒₚₜᵢ | Power consumption for Vₒₚₜᵢ |
|---|---|
| Condenser(s) 12 | Colling tower(s) |
| differential temp.: | 14 vs. condenser |
| T_{2, cond}-T_{1, cond} | pump(s) 10 & heat pum(p) 13 |
| Dry cooler fan(s) 16 speed, n | Condenser pump(s) 10 & dry cooler |
| | fan(s) 16 |
| Approach temp.: T_{ambient}-T_{1, cond} | Cooling tower(s) 14 vs. condenser |
| (T_{ambient} may be dry bulb | pump(s) 10 & heat pump 13 |
| or wet bulb temperature) | |
| Cooling tower(s) (wet) | Cooling tower spray pump(s) & |
| fan 17 speed, n | cooling tower fan(s) 16 |
| Cooling tower(s) (wet) | Cooling tower spray pump(s) 8 & |
| pump 8 speed, n | cooling tower fan(s) 17 |
| Differential temp. evaporator(s) 6: | Heat pump(s) 13 & evaporator |
| T_{2, evap}-T_{1, evap} | pump(s) 9 |
| Evaporator(s) 6 outlet temperature: | Heat pump(s) 13 & evaporator |
| T_{1, evap} | pump(s) 9 |

These optimization parameters will be detailed with reference to preferred embodiments in the following.

In some preferred embodiments, the heat transport device 3 comprising a condenser 5 receiving the second fluid from the first thermal load 2 at first condenser temperature (T_{1,cond}) and delivering the second fluid to the first thermal load (2) at a second condenser temperature (T_{2cond}). In such embodiments, the optimization parameter may be selected to be the difference between the first and the second condenser temperatures and summed power consumption Pₛᵤₘ is selected as the sum of the first thermal load power consumption and the heat transport device 3 power consumption. The first thermal load power consumption may, e.g., be power used to drive a pump circulating fluid or to power a fan used to flow air (or other fluid) through the first thermal load. The power consumption of the heat transport device may be the power used to drive a component such as compressor or a total power consumption of the heat transport device.

In embodiments including a wet cooling tower comprising a spray pump 8 and fan 7, the optimization parameter Vₒₚₜᵢ may be the speed of the fan 7 or the speed spray pump 8.

In preferred embodiments the first thermal load 2 comprises a cooling tower 14 through which the second fluid flows in one or more flow channels. The cooling tower further comprises a cooling tower fan 7 (see e.g. FIG. 5) configured to drive a flow of air through the cooling tower 2 and past the one or more flow changes.

In addition, the cooling tower may be a wet cooling tower and comprise a spray pump 8 to spray water onto said one or more flow channels. In such embodiments, the optimization parameter may be selected as a speed of said cooling tower fan 7 which is related to the power consumption of the cooling tower fan 7. The summed power consumption Pₛᵤₘ may in such embodiment be the sum of the power used to operate cooling tower fan 7 and the power used to operate the spray pump 8. In preferred embodiment the power consumption of the cooling tower fan 7 is measured.

In embodiments where the transport device comprises a condenser, the optimization parameter may be selected as the difference between an ambient temperature at which the first thermal load 2 operates and the first condenser temperature (T_{1,cond}). The summed power consumption Pₛᵤₘ may be the (overall) sum of the first thermal load 2 power consumption and the heat transport device 3 power consumption.

In some preferred embodiments, the heat transport device comprising a condenser and the first thermal load 2 comprises a dry cooling tower 15 through which the second fluid flows in one or more flow channels. Such a dry cooling tower 15 may also comprise a dry cooler fan 16 configured to drive a flow of air through the dry cooler 15 and past the one or more flow channels as illustrated in FIG. 6. The one or more flow channels are typically configured as a heat exchanger allowing air to pass through. The optimization parameter may in such embodiments be selected as a speed of dry cooler fan 16 and the summed power consumption Pₛᵤₘ may be the sum of the power used to operate the second pump 10 and a power used to operate the dry cooler fan 16.

In embodiments wherein the transport device comprising a condenser and the heat absorption side 11 comprises an evaporator 6 delivering the first fluid to the second thermal load 4 at a first evaporator temperature, T_{1,evap}, and receiving the first fluid from said second thermal load 4 at a second evaporator temperature, T_{2,evap}, and the first pump 9 is arranged to circulate said first fluid between the evaporator 6 and the second thermal load 4, the optimization parameter may be selected as the difference between the second and first evaporator temperature or said first evaporator temperature, and the summed power consumption Pₛᵤₘ may be the sum of the power used to operate the second pump 9 and a heat pump 13.

In embodiments of the invention, the convex function, Pₛᵤₘ, being the sum of n, where n is two or more, system power readings are repeatedly undergoing a search for its minima during changing operating conditions. By manipulating the control variable Vₒₚₜᵢ with a change, which may be referred to as a optimization signal ∈, a manipulated set-point:

$${V}_{opti} ( k ) = {V}_{opti} ( k - 1 ) + ϵ ( k ) ,$$

where |∈|>0 is obtained and observing the rate of change of summed power consumption with respect to the optimization parameter:

$$\frac{Δ {P}_{sum}}{Δ {V}_{opti}} = \frac{{P}_{sum} ( k ) - {P}_{sum} ( k - 1 )}{{V}_{opti} ( k ) - {V}_{opti} ( k - 1 )}$$

also referred to as the derivative

$$\frac{{dP}_{sum}}{{dV}_{opti}}$$

a search for a minimum is performed for the system components considered. Kindly observe that

$$\frac{Δ P}{Δ {V}_{opti}}$$

is a discretization of

$$\frac{{dP}_{sum}}{{dV}_{opti}}$$

being useful in evaluating the rate of change. The optimization step k is incremented when conditions discussed later are fulfilled.
By observing the sign of derivative

$$\frac{{dP}_{sum}}{{dV}_{opti}}$$

a search for a minimum in Pₛᵤₘ performed. In FIG. 2, the derivative is also disclosed.

In some preferred embodiments, the optimization is based on that if:

$${\frac{{dP}_{sum}}{{dV}_{opti}} < 0 \vert}_{ϵ > 0}$$

the optimization continues with a positive ∈ while if

$${\frac{{dP}_{sum}}{{dV}_{opti}} > 0 \vert}_{ϵ > 0}$$

The optimization continues with a negative ∈.

This may be interpreted as if power consumption increases with positive ∈ leads to the optimization changing sign of ∈ in search for the minima and thus ∈<0. Thus, in preferred embodiments, the search for the derivative

$$\frac{{dP}_{sum}}{{dV}_{opti}} = 0$$

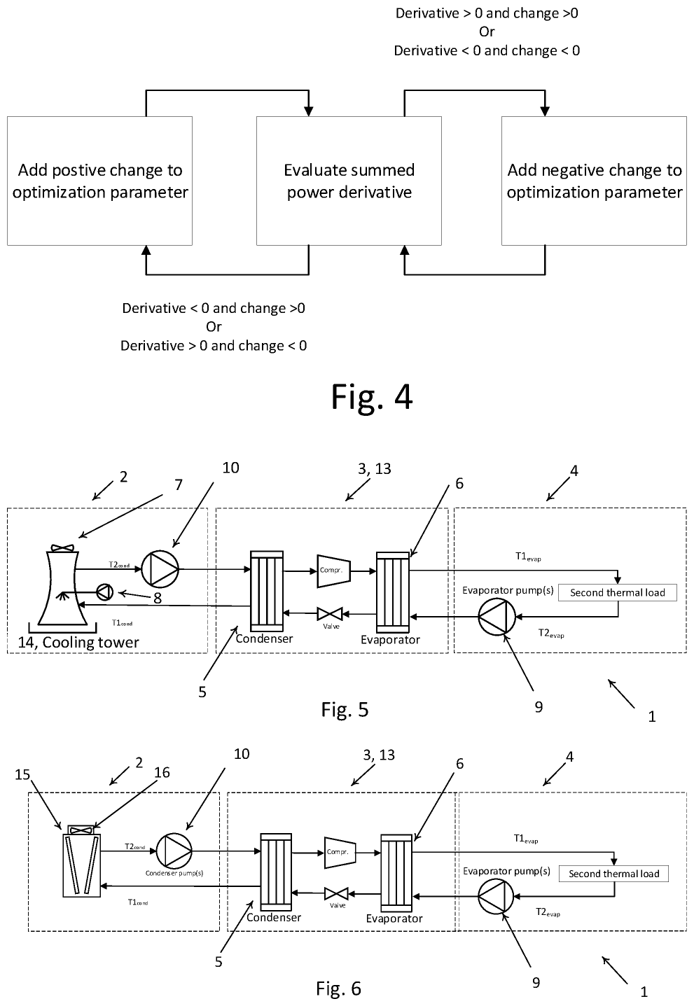

is carried out, preferably repeatedly. A preferred embodiment of this is schematically illustrated in FIG. 4.

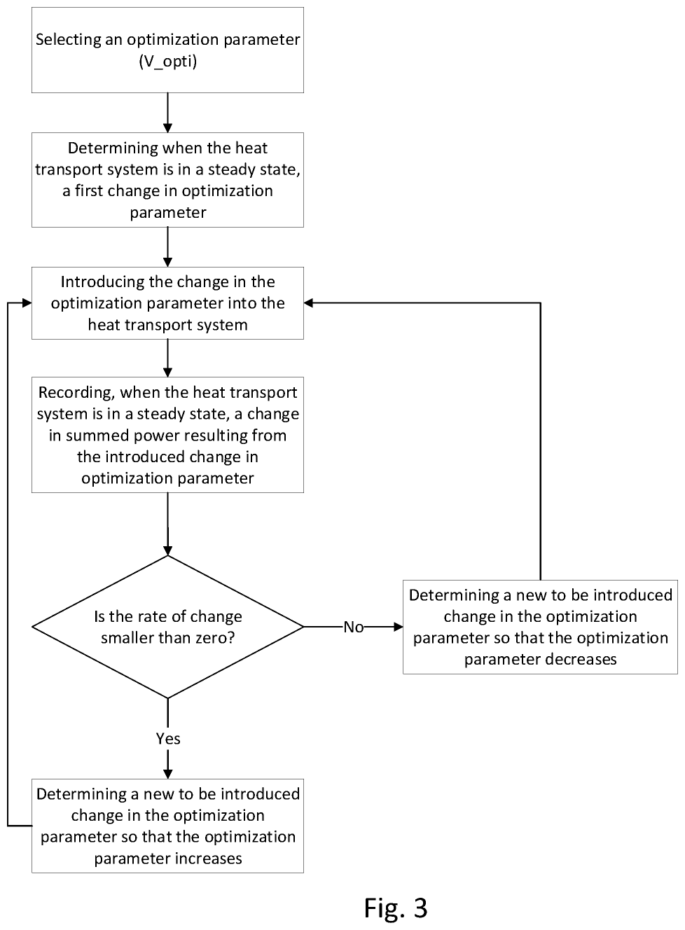

With reference to FIG. 3, a preferred embodiment of a method of optimizing the energy consumption of a heat transport system will now be detailed. As detailed above, the method is based on an optimization parameter Vₒₚₜᵢ indicative of or representing a summed power consumption Pₛᵤₘ. Indicative of a summed power consumption Pₛᵤₘ refers to a situation where the power consumption is not determined directly by a measurement, but instead expressed in parameters measured. Such parameters may be pressure drop, temperature differences or the like.

As disclosed above, the summed power consumption is a sum of at least two of power consumptions which when summarized has a convex power consumption characteristic as a function of the optimization parameter Vₒₚₜᵢ. The summed power consumption is changeable by introducing a change to the optimization parameter (e.g. e detailed above) into the heat transport system.

In the preferred embodiment, the method comprising an initial step a) involving determining a first to be introduced change in the optimization parameter and introducing this first to be introduced change into the heat transport system. This step a) may be seen as a way of initiating the optimization method, as subsequent steps preferably are executed in a loop. The value of the first to be introduced change is typically selected to be a small value to avoid introducing larger changes which might result in e.g. an unstable operation of the heat transport system.

By introducing this first to be introduced change, the heat transport system or at least the components affected by the change response with a new operating state, which also may be referred to as a new set-point, and the summed power consumption at this new operating state is recorded.

Based on the new operating state, a step b) is executed which involves recording a power consumption change in said summed power consumption dPₛᵤₘ resulting from the change in said optimization parameter introduced into heat transport system. This may conceptually be written as

$$Δ {P}_{k} = {P}_{k} - {P}_{k - 1}$$

where index k refers the new operating state, and index k−1 refers to the previous operating state prior to introducing the change. A change in optimization parameter Vₒₚₜᵢ is typically determined in a similar manner. In some embodiments, the rate of change is calculated and in other embodiments the value or sign of dPₛᵤₘ is determined and as well as the sign of dVₒₚₜᵢ is determined. By this the sign of the rate of change can be determined and used for determining whether the optimization parameter is to be increased or decreased as outlined above.

With the information as to change:

$$\frac{{dP}_{sum}}{{dV}_{opti}}$$

a step c) is carried out which involves determining a new to be introduced change to the optimization parameter.

This new to be introduced change is determined so that it results in
an increase in said optimization parameter, if a rate of change in summed power consumption with respect to the optimization parameter

$$\frac{{dP}_{sum}}{{dV}_{opti}}$$

is smaller than zero, and
a decrease in said optimization parameter, if said rate in change of summed power consumption with respect to the optimization parameter

$$\frac{{dP}_{sum}}{{dV}_{opti}}$$

is larger than zero,

With this determined to be introduced change, a step d) is carried out which involves introducing the new to be introduced change into the heat transport system and repeating steps b) to d). It is noted that steps a), b) and d) are performed when the heat transport system is in steady state.

As the introduction of a change in the optimization parameter into the heat transport system results in a change in operation of the heat transport system, the change in optimization parameter as well as recording a power consumption change in summed power consumption are made when the heat transport system is in an steady state. Preferred embodiments of this are detailed here below.

It may be advantageous not to introduce larger changes into the heat transport system as this may, e.g., overshoot the minimum. To accomplish this or other purposes, preferred embodiments of the method may involve that the to be introduced change to the optimization parameter is bound to be limited by an upper and lower limit. In preferred embodiments, the upper and lower limits are defined by a possible operating range of the optimization parameter.

Limits on Vₒₚₜᵢ can be defined in numerous ways and two ways determining the limits are disclosed in the following. In the following two methods for limiting Vₒₚₜᵢ are defined.

$${V}_{opti} ( k ) = {V}_{opti} ( k - 1 ) + ϵ ( k )$$

Where Vₒₚₜᵢ(k) is limited to the range:

$$a \leq {V}_{opti} ( k ) \leq b$$

The limits a and b can be defined by the operating range of Vₒₚₜᵢ itself. E.g. for condenser water temperature from cooling tower to chiller Vₒₚₜᵢ=T_{2cond} the limits would be a=T_{ambient} and b=T_{1cond} thus the range for Vₒₚₜᵢ would be [T_{ambient},T_{1cond}] corresponding to the cooling tower either cooling the condenser water to ambient temperature (only theoretical possible) or not cooling the condenser water at all.

Another approach is to define the upper and lower bounds for Vₒₚₜᵢ by limits imposed by the affected components. Non-limiting examples available metrics may be the max power consumption for each component or a plurality of components in the optimization. For example, in the case of optimization of cooling tower and heat transport device the lower limit of Vₒₚₜᵢ is typically reached when the cooling tower reaches its maximum rated power consumption.

In preferred embodiments the rate of change is determined as the derivative of the change in power consumption with respect to the optimization parameter, which may be determined by calculating the rate of change:

$$\frac{{dP}_{sum}}{{dV}_{opti}}$$

Numerous ways are available to calculate this first derivative, and in preferred embodiments, the derivative is determined by a first order finite difference approximation:

$$\frac{{dP}_{sum}}{{dV}_{opti}} \approx \frac{Δ {P}_{sum}}{Δ {V}_{opti}}$$

However, higher order approximations may be used.

In embodiment where the derivative

$$\frac{{dP}_{sum}}{{dV}_{opti}}$$

is determined, the change (new to be introduced change) may advantageously be determined proportional to the magnitude of the derivative, which may be referred to as scaling the change according to the magnitude of the derivative.

Scaling the change may ensures stable behavior around an equilibrium while ensuring reasonable response times to the introduced change into the heat transport system state. Such a scaling may be referred to as dynamic sensitivity adjustment and can be carried out in numerous ways. In the following two preferred embodiments are detailed.

The change, here labelled e introduced to Vₒₚₜᵢ is adjusted, preferably continuously, in amplitude with respect to the derivative observed:

$$\vert ϵ \vert ∝ \frac{{dP}_{sum}}{{dV}_{opti}}$$

such that low amplitude derivative responses to change ∈ results in lower amplitude changes ∈ until lower bound is met, whereas also an upper bound for ∈ is defined for large amplitude derivative responses to ensure stable operation while ensuring reasonable response time. This may be formulated as:

$${ϵ}_{min} \leq \vert ϵ \vert \leq {ϵ}_{max}$$

These bounds are preferably defined by the process carried out by the components related to Vₒₚₜᵢ. The bounds ∈ₘᵢₙ and ∈ₘₐₓ can either be set manually as fractions of the design set-point for Vₒₚₜᵢ or by evaluating the power consumption response to a given optimization signal amplitude.

This can explicitly be done by defining a minimum and maximum allowable

$$\frac{{dP}_{sum}}{{dV}_{opti}} or \frac{{dP}_{sum}}{dt}$$

response. In other words, reducing or increasing |∈| until a given threshold for either

$$\frac{{dP}_{sum}}{{dV}_{opti}} or \frac{{dP}_{sum}}{dt}$$

is observed.

If a small ∈ₘᵢₙ value is chosen, ∈ can repeatedly be increased above ∈ₘᵢₙ to ensure that the optimization does not end up in a locked situation.

To confidently determine

$$\frac{{dP}_{sum}}{{dV}_{opti}} ,$$

minor fluctuations and sensor noise, should preferably be neglected while features exposing the sign and magnitude of the derivative as well as change of system state into and out of highly dynamical states advantageously could be used. Thus, filtering, detection of stable condition and change detection may be required.

In preferred embodiments, this is implemented in a manner where the recording of the power consumption change in summed power consumption is determined at an steady state of said heat transport system. Steady state typically refers to that Pₛᵤₘ does not change more than 5% such as more than 2.5% evaluated over a time period of typically 5.0 minutes or more, preferably less than 15.0 minutes. Such a steady state may be referred to as a plateau as Pₛᵤₘ is constant over time.

The values of Pₛᵤₘ used in the evaluation is typically filtered. In some embodiments, the filtering is based a sampling storing sampling data, Pₛᵤₘ, in a FIFO buffer. An average is calculated by summing the data in the FIFO buffer and dividing the sum with the number of data. Such a filtering may be referred to as a low-pass filtering.

In some embodiments, a windowed CUSUM (cumulative sum control chart) algorithm is applied to the raw sensor data. The CUSUM uses both the data standard deviation and the calculated mean from the moving average which enables detection of power change in power consumption and evaluating when the system has settled at a new power consumption plateau, that is settled at a new steady state. In this CUSUM method, the sensor data are normalized and centered around the mean as shown here for the detection of positive deviations:

$${S}_{H m} = max ( 0 , {S}_{H m - 1} + \frac{{X}_{m} - \overline{x}}{{σ}_{X}} )$$

$${S}_{L m} = max ( 0 , {S}_{L m - 1} - \frac{{X}_{m} - \overline{x}}{{σ}_{X}} )$$

Where Xₘ is observation at time m, x̅ is the mean of the windowed observations, ox the standard deviation of the windows observations and H and L refers to negative and positive change detection.

Accordingly, a measure of the signal standard deviation and mean is constructed at a stable condition, e.g., prior to applying a change to the optimization parameter and prior to introducing the change, where after the CUSUM algorithm is used for detecting a change based on the standard deviation and obtained mean.

Other embodiments are based on a windowed real-time linear regression, typically using a FIFO buffer of sample size n, to repeatedly construct a linear regression model of the summed power consumption readings:

$${P}_{sum} = at + b + o$$

Here a is the slope and b is a constant both found by the regression. t is time.

By evaluating the standard deviation error, contained in o, of the obtained parameter-set for the linear model and the slope a both a power change in power consumption can be detected as well as a settling of the power consumption at a new plateau enabling calculation of

$$\frac{{dP}_{sum}}{{dV}_{opti}} .$$

The linear regression parameter b represents the power consumption and is recorded both prior and after introducing the change.

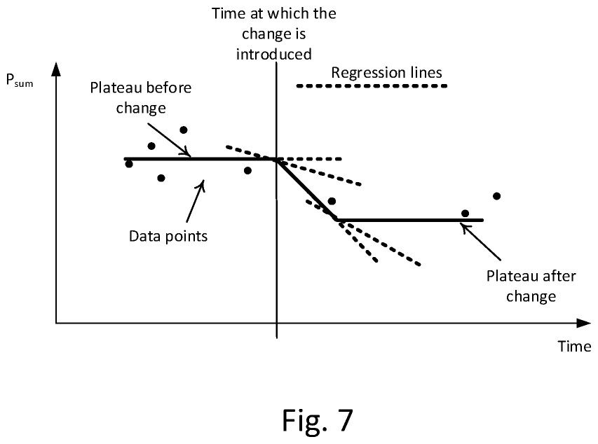

FIG. 7 schematically illustrates a timewise evolution in Pₛᵤₘ as well as illustrating a plateau before and after introducing a change. As can be seen in FIG. 7, the regression lines have a negative slope after the change is introduced and the slope goes gradually goes towards zero when the plateau after introduction of the change has occurred. A similar reasoning can be made if the power consumption increases after introduction of a change, in which case the slope is positive upon introduction of the change and gradually goes to zero when the new plateau has been reached. It is noted that FIG. 7 illustrates one progression over time of Pₛᵤₘ, where Pₛᵤₘ is decreasing over time. However, at other times Pₛᵤₘ may increase with time.

It has been observed that at a steady state, the slope a is zero, that a≈0 while the standard deviation error settles at some value as well. Further, the standard deviation increases when slope a begins to change. Accordingly, the standard deviation error may be used as a good measure for detecting the result of an introduced change while the slope parameter a may be used to provide information of whether the system is settled at a plateau, that is at a steady state.

A standard deviation error “baseline” is typically determined by evaluating the standard deviation error against a pre-defined value and/or by observing the slope parameter a which expectedly would be close to zero.

In preferred embodiments, the standard deviation error “baseline” is found by evaluating the standard deviation error against a pre-defined value and/or by observing the slope parameter a, which should be a≈0 during constant load conditions, that is at a steady state.

With the determination of a steady state before and after introduction of a change, preferred embodiments of the method involves that the recording of power change in the summed power consumption resulting from a change in the optimization parameter introduced into the heat transport system is carried out when the summed power consumption has reached a new steady state being different from a previous steady state prevailing prior to introducing the change in the optimization parameter. Further, the to be introduced change is introduced after the new steady state has been reached.

In preferred embodiments, this is implemented by the method comprises a sampling of summed power consumption prior to and after introducing the new to be introduced change thereby providing summed power consumption data representing summed power consumption as function of time. Based on this, the method identifies in the summed power consumption data, if present:
the previous steady state
   as a first steady summed power consumption occurring prior to and
the new steady state
   as a second steady summed power consumption occurring after said introducing said new to be introduced change.

With these first and second steady states identified, the recording of the power change in summed power consumption (dP) is recorded based on the first and second steady summed power consumptions.

In preferred embodiments, the first and second steady summed power consumptions are identified by use of a cumulative sum control chart (CUSUM) as detailed above.

In other preferred embodiments, the method comprises that.
first and said second steady summed power consumptions are identified by use of a linear regression,
said linear regression is based on a sliding time window including a sub-set of said summed power consumption data, and.
said first and second steady summed power consumptions are identified by a slope of the linear regression being substantially zero
   as detailed above.

In highly dynamic situations where discontinuities may appear in the optimization, the optimization is preferably halted. In such halted scenarios, the controlled optimization variable \hat{V}ₒₚₜᵢ is locked by setting the optimization signal ∈ (the change) to 0 when the highly dynamic situation is detected. Such a highly dynamic situation is typically followed by a more stable situation at which time the optimization continues preferably by initiating the change with ∈=∈ₘᵢₙ. Such highly dynamic situations may be caused by staging or de-staging of cooling towers or chillers or abrupt load changes.

Situations were halting the optimization may be preferred, can be detected in numerous ways. In the following examples are explicitly described.

Evaluating the power change in summed power consumption with respect to time will reveal sudden changes to the power consumption caused by, e.g., staging of chillers:

$$\frac{{dP}_{sum}}{dt} > Δ {P}_{lim}$$

In preferred embodiments, an operation for each of the first thermal load 2, the heat transport device 3 and the second thermal load 4 are each controlled by individual closed loops control operating on the basis of set-points representing a thermal specification to be met by first thermal load 2, the heat transport device 3 and the second thermal load 4. Such an individual control loops set the first thermal load 2, the heat transport device 3 and the second thermal load 4 at steady set after a change in set-point within a first settling time.

To avoid producing instabilities in the heat transport system during optimization a new to be introduced change into the heat transport system is carried at time intervals being larger than said first settling time, such as at least five times larger, preferably at least ten times larger than said first settling time.

Preferred embodiments may use a direct measurement of the summed power consumption and/or the summed power consumption may be determined based on parameters indicative of the power consumption.

With reference to FIG. 5, the power consumption of the heat pump 13 P_{heat pump}, can be estimated by using a power conservation approach on the heat pump 13. The thermal power that leaves the evaporator side of heat pump Qₑᵥₐₚ, must be the same as the thermal power that enters at the condenser side of heat pump Q_{con}, plus a power consumption of the heat pump (P_{heat pump}). The power consumption has two contributions first the work added to refrigerant gas (A_{chiller}), and secondly the thermal power lost as conducted and convected heat from the cooling machine (Q_{chiller}).

$${Q}_{con} = {q}_{con} {c}_{p \_ con} {ρ}_{con} ( T {2}_{con} - T {1}_{c o n} )$$

$${Q}_{eνap} = {q}_{eνap} {c}_{p \_ eνap} {ρ}_{eνap} ( T {2}_{eνap} - T {1}_{eνap} )$$

$${Q}_{eνap} = {Q}_{con} + {P}_{chiller}$$

$${P}_{chiller} = {A}_{chiller} + {Q}_{chiller}$$

The power consumption can be estimated by subtracting the thermal power at the condenser side from the thermal power on the evaporator side of chiller. When calculating the power consumption, it can be an advantage to first subtract the two thermal power components from one another, and then make a lowpass filtering of the result.

An offset calibration of the estimation of power consumption, could be done by operating the condenser and evaporator pumps for a while, without turning on the heat pump, in this situation the thermal power on the evaporator side should be the same as thermal power on the condenser side, so any difference between the two thermal power values, could be considered as an offset.

### List of Reference Symbols Used

1 Heat transport system

2 First thermal load

3 Heat transport device

4 Second thermal load

5 Condenser

6 Evaporator

7 Cooling tower fan

8 Spray pump

9 First pump

10 Second pump

11 Heat absorption side

12 Heat rejection side

13 Heat pump

14 Cooling tower

15 Dry cooler

16 Dry cooler fan

17 Heat pump

18 Chiller

P Power consumption

P_{ct} Power consumption of cooling tower

Pₕₚ Power consumption of heat pump

Pₕₗ Power consumption of second thermal load

Vₒₚₜᵢ Optimization parameter

Itemized list of preferred embodiments

Item 1. A method for optimizing the energy consumption of a heat transport system (1), said heat transport system comprising:
a first thermal load (2), a heat transport device (3) and a second thermal load (4), said heat transport device being configured to
   a) extract heat from a first fluid circulating by use of a first pump (9) between a heat absorption side (11) of said heat transport device (3) and said second thermal load (4) and supply at least a fraction of said heat to a second fluid circulating by use of a second pump (10) between said first thermal load (2) and a heat rejection side of (12) said heat transport device (3);
      wherein
operation of said first thermal load (2), said heat transport device (3) and said second thermal load (4) each requires a power consumption (P);
the method is based on an optimization parameter (Vₒₚₜᵢ) indicative of or representing a summed power consumption (Pₛᵤₘ) for two or more components of the heat transport system, wherein said summed power consumption being a sum of at least two of said power consumptions which when summarized has a convex power consumption characteristic as a function of the optimization parameter and wherein said summed power is changeable by introducing a change to the optimization parameter into the heat transport system, the method comprising, the steps of:
   a) determining when the heat transport system is in a steady state a first to be introduced change in the optimization parameter and introducing said first to be introduced change into the heat transport system;
   b) recording when the heat transport system is in a steady state, a power change in said summed power (dPₛᵤₘ) resulting from said change in said optimization parameter introduced into said heat transport system;
   c) determining a new to be introduced change to the optimization parameter, wherein said new to be introduced change results in:
      an increase in said optimization parameter, if a rate of change in summed power consumption with respect to said optimization parameter

$$( \frac{{dP}_{sum}}{{dV}_{opti}} )$$

is smaller than zero, and
a decrease in said optimization parameter, if said rate of change in summed power consumption with respect to said optimization parameter

$$( \frac{{dP}_{sum}}{{dV}_{opti}} )$$

is larger than zero,
d) introducing when the heat transport system is in steady state said new to be introduced change into the heat transport system and repeating steps b) to d).

Item 2. A method according to item 1, wherein said heat transport device (3) comprising a condenser (5) receiving said second fluid from the first thermal load (2) at first condenser temperature (T_{1,cond}) and delivering said second fluid to the first thermal load (2) at a second condenser temperature (T_{2cond}).

Item 3. A method according to item 2, wherein the optimization parameter is the difference between the first and the second condenser temperatures and said summed power consumption (P) is the sum of the first thermal load power consumption and the heat transport device (3) power consumption.

Item 4. A method according to any one of the preceding items, wherein the first thermal load (2) comprising a cooling tower (14) through which the second fluid flows in one or more flow channels, said cooling tower comprising a cooling tower fan (7) configured to drive a flow of air through the cooling tower (2) and past said one or more flow changes, and a spray pump (8) to spray water onto said one or more flow channels, and wherein the optimization parameter is a speed of said cooling tower fan (7), and wherein said summed power consumption (P) is the sum of the power used to operate said cooling tower fan (7) and the power used to operate the spray pump (8).

Item 5. A method according to item 2, wherein the optimization parameter is the difference between an ambient temperature at which the first thermal load (2) operates and said first condenser temperature (T_{1,cond}), and wherein said summed power consumption (P) is the sum of the first thermal load (2) power consumption and the heat transport device (3) power consumption.

Item 6. A method according to item 2, wherein the first thermal load (2) comprises a dry cooler (15) through which the second fluid flows in one or more flow channels and a dry cooler fan (16) configured to drive a flow of air through said dry cooler (15) and past said one or more flow channels, wherein second pump (10) is arranged to circulate said second fluid between the heat rejection side and through the first thermal load (2), wherein the optimization parameter is a speed of said dry cooler fan (16) and wherein said summed power consumption (P) is the sum of the power used to operate said second pump (10) and a power used to operate said dry cooler fan (16).

Item 7. A method according to any one of the preceding items 2-5, wherein the heat absorption side (11) comprising an evaporator (6) delivering said first fluid to said second thermal load (4) at a first evaporator temperature (T_{1,evap}) and receiving said first fluid from said second thermal load (4) at a second evaporator temperature (T_{2,evap}), wherein the first pump (9) is arranged to circulate said first fluid between said evaporator (6) and said second thermal load (4), and wherein the optimization parameter is the difference between the second and first evaporator temperature or said first evaporator temperature, wherein said summed power consumption (P) is the sum of the power used to operate said first pump (9) and a heat pump (13).

Item 8. A method according to any one of the preceding items, wherein said to be introduced change to the optimization parameter is bound to be limited by an upper and lower limit, where said upper and lower limits are defined by a possible operating range of the optimization parameter.

Item 9. A method according to claim to any one of the preceding items, wherein a magnitude of said to be introduced change is determined proportional to said rate of change of summed power consumption with respect to said optimization parameter.

Item 10. A method according any one of the preceding items, wherein said recording of said power change in summed power consumption is determined at a steady state of said heat transport system.

Item 11. A method according to item 10, wherein
said recording a power change in said summed power consumption resulting from said change in said optimization parameter introduced into said heat transport system is carried out when the summed power consumption has reached a new steady state being different from a previous steady state prevailing prior to introducing said change in the said optimization parameter, and
said to be introduced change is introduced after said new steady state has been reached.

Item 12. A method according to any one of the preceding items, wherein the heat transport device (3) comprising a heat pump (17).

Item 13. A method according to any one of the preceding items 1-10, wherein the heat transport device (3) comprising a chiller (18).

Item 14. A method according to any one of the preceding items 11-13, further comprising
sampling of summed power consumption prior to and after said introducing said new to be introduced change thereby providing summed power consumption data representing summed power consumption as function of time, and
identifying in said summed power consumption data, if present,
   said previous steady state
      as a first steady summed power consumption occurring prior to and
   said new steady state
      as a second steady summed power consumption occurring after said introducing said new to be introduced change;
         wherein said recording a power change in summed power consumption (dP) is recorded based on said first and second steady summed power consumptions.

Item 15. A method according to item 14, wherein said first and second steady summed power consumptions are identified by use of a cumulative sum control chart (CUSUM).

Item 16. A method according to item 15, wherein
said first and said second steady summed power consumptions are identified by use of a linear regression,
said linear regression is based on a sliding time window including a sub-set of said summed power consumption data, and
said first and second steady summed power consumptions are identified by a slope of the linear regression being substantially zero.

Item 17. A method according to any one of the preceding items, wherein.
an operation for each of said first thermal load (2), said heat transport device (3) and said second thermal load (4) is controlled by a common or individual control loops operating on the basis of set-points representing a thermal specification to be met by first thermal load 2, the heat transport device 3 and the second thermal load 4, and
said common or individual control loops set said first thermal load (2), said heat transport device (3) and said second thermal load (4) at steady set after a change in set-point within a first settling time, and
said introducing a new change to be introduced into the heat transport system is carried at time intervals being larger than said first settling time, such as at least five times larger, preferably at least ten times larger than said first settling time.

1. A method for optimizing the energy consumption of a heat transport system (1), said heat transport system comprising:
a first thermal load (2), a heat transport device (3) and a second thermal load (4), said heat transport device being configured to
a) extract heat from a first fluid circulating by use of a first pump (9) between a heat absorption side (11) of said heat transport device (3) and said second thermal load (4) and supply at least a fraction of said heat to a second fluid circulating by use of a second pump (10) between said first thermal load (2) and a heat rejection side of (12) said heat transport device (3);
wherein
operation of said first thermal load (2) and said second pump (10), said heat transport device (3) and said second thermal load (4) and said first pump (9) each requires a power consumption (P);
the method is based on an optimization parameter (Vₒₚₜᵢ) indicative of or representing a summed power consumption (Pₛᵤₘ) for two or more components of the heat transport system, wherein said summed power consumption being a sum of at least two of said power consumptions which when summarized has a convex power consumption characteristic as a function of the optimization parameter and wherein said summed power consumption is changeable by introducing a change to the optimization parameter into the heat transport system, the method comprising, the steps of:
a) determining when the heat transport system is in a steady state a first to be introduced change in the optimization parameter and introducing said first to be introduced change into the heat transport system;
b) recording when the heat transport system is in a steady state, a power consumption change in said summed power consumption (dPₛᵤₘ) resulting from said change in said optimization parameter introduced into said heat transport system;
c) determining a new to be introduced change to the optimization parameter, wherein said new to be introduced change results in:
an increase in said optimization parameter, if a rate of change in summed power consumption with respect to said optimization parameter
$$( \frac{{dP}_{sum}}{{dV}_{opti}} )$$
is smaller than zero, and
a decrease in said optimization parameter, if said rate of change in summed power consumption with respect to said optimization parameter
$$( \frac{{dP}_{sum}}{{dV}_{opti}} )$$
is larger than zero,
d) introducing when the heat transport system is in steady state said new to be introduced change into the heat transport system and repeating steps b) to d).

2. A method according to claim 1, wherein said heat transport device (3) comprising a condenser (5) receiving said second fluid from the first thermal load (2) at first condenser temperature (T_{1,cond}) and delivering said second fluid to the first thermal load (2) at a second condenser temperature (T_{2cond}).

3. A method according to claim 2, wherein the optimization parameter is the difference between the first and the second condenser temperatures and said summed power consumption (P) is the sum of the first thermal load power consumption and the heat transport device (3) power consumption.

4. A method according to claim 1, wherein the first thermal load (2) comprising a cooling tower (14) through which the second fluid flows in one or more flow channels, said cooling tower comprising a cooling tower fan (7) configured to drive a flow of air through the cooling tower (2) and past said one or more flow changes, and a spray pump (8) to spray water onto said one or more flow channels, and wherein the optimization parameter is a speed of said cooling tower fan (7), and wherein said summed power consumption (P) is the sum of the power used to operate said cooling tower fan (7) and the power used to operate the spray pump (8).

5. A method according to claim 2, wherein the optimization parameter is the difference between an ambient temperature at which the first thermal load (2) operates and said first condenser temperature (T_{1,cond}), and wherein said summed power consumption (P) is the sum of the first thermal load (2) power consumption and the heat transport device (3) power consumption.

6. A method according to claim 2, wherein the first thermal load (2) comprises a dry cooler (15) through which the second fluid flows in one or more flow channels and a dry cooler fan (16) configured to drive a flow of air through said dry cooler (15) and past said one or more flow channels, wherein second pump (10) is arranged to circulate said second fluid between the heat rejection side and through the first thermal load (2), wherein the optimization parameter is a speed of said dry cooler fan (16) and wherein said summed power consumption (P) is the sum of the power used to operate said second pump (10) and a power used to operate said dry cooler fan (16).

7. A method according to claim 2, wherein the heat absorption side (11) comprising an evaporator (6) delivering said first fluid to said second thermal load (4) at a first evaporator temperature (T_{1,evap}) and receiving said first fluid from said second thermal load (4) at a second evaporator temperature (T_{2,evap}), wherein the first pump (9) is arranged to circulate said first fluid between said evaporator (6) and said second thermal load (4), and wherein the optimization parameter is the difference between the second and first evaporator temperature or said first evaporator temperature, wherein said summed power consumption (P) is the sum of the power used to operate said first pump (9) and a heat pump (13).

8. A method according to claim 1, wherein said to be introduced change to the optimization parameter is bound to be limited by an upper and lower limit, where said upper and lower limits are defined by a possible operating range of the optimization parameter.

9. A method according to claim 1, wherein a magnitude of said to be introduced change is determined proportional to said rate of change of summed power consumption with respect to said optimization parameter.

10. A method according any claim 1, wherein said recording of said power change in summed power consumption is determined at a steady state of said heat transport system.

11. A method according to claim 10, wherein
said recording a power change in said summed power consumption resulting from said change in said optimization parameter introduced into said heat transport system is carried out when the summed power consumption has reached a new steady state being different from a previous steady state prevailing prior to introducing said change in the said optimization parameter, and
said to be introduced change is introduced after said new steady state has been reached.

12. A method according to claim 1, wherein the heat transport device (3) comprising a heat pump (17).

13. A method according to claim 1, wherein the heat transport device (3) comprising a chiller (18).

14. A method according to claim 8, further comprising
sampling of summed power consumption prior to and after said introducing said new to be introduced change thereby providing summed power data representing summed power consumption as function of time, and
identifying in said summed power consumption data, if present,
said previous steady state
as a first steady summed power consumption occurring prior to and
said new steady state
as a second steady summed power consumption occurring after said introducing said new to be introduced change;
wherein said recording a power change in summed power consumption (dP) is recorded based on said first and second steady summed power consumptions.

15. A method according to claim 14, wherein said first and second steady summed powers are identified by use of a cumulative sum control chart (CUSUM).

16. A method according to claim 14, wherein
said first and said second steady summed powers consumptions are identified by use of a linear regression,
said linear regression is based on a sliding time window including a sub-set of said summed power consumption data, and
said first and second steady summed power consumptions are identified by a slope of the linear regression being substantially zero.

17. A method according to claim 1, wherein
an operation for each of said first thermal load (2), said heat transport device (3) and said second thermal load (4) is controlled by a common or individual control loops operating on the basis of set-points representing a thermal specification to be met by first thermal load (2), the heat transport device (3) and the second thermal load 4, and
said common or individual control loops set said first thermal load (2), said heat transport device (3) and said second thermal load (4) at steady set after a change in set-point within a first settling time, and
said introducing a new change to be introduced into the heat transport system is carried at time intervals being larger than said first settling time, such as at least five times larger, preferably at least ten times larger than said first settling time.
